(19) United States
(12) Patent Application Publication
(10) Pub. No.: US 2007/0088789 A1
(43) Pub. Date: Apr. 19, 2007

(54) Method and system for indicating an email sender as spammer

(76) Inventor: Reuben Berman, Beer-Sheva (IL)

Correspondence Address: D.R. MARK FRIEDMAN LTD.;C/o Bill Polkinghorn, 9003 Florin Way, Upper Marlboro, MD, 20772, US

(21) Appl. No.: 11/251,819

(22) Filed: Oct. 18, 2005

(51) Int. Cl. G06F 15/16

(52) U.S. Cl. 709/206; 709/207

(57) ABSTRACT

In one aspect the present invention is directed to a method for indicating a sender of an email message as spammer, the method comprising the steps of: obtaining an identifier associated with the real identity of the sender; relating the email message to the identifier; calculating the mail flow rate of the identifier; and if the mail flow rate exceeds a predefined threshold, determining the real sender associated with the identifier as a suspected spammer and/or the determining email as suspected of being spam. The method may further comprise the step of: adding to the email message indication about being spam according to the determining; and digitally signing the email message with a private key.

### FIELD OF THE INVENTION

The present invention relates to the field of detecting and blocking spam.

### BACKGROUND OF THE INVENTION

Spam, also referred to as “unsolicited bulk email”, or “junk” email, is undesired email that is sent to multiple recipients, with the purpose of promoting a business, an idea or a service. Spam is also used by hackers to spread vandals and viruses in email, or to trick users into visiting hostile or hacked sites which attack innocent surfers. Spam usually promotes “get rich quickly” schemes, porn sites, travel/vacation services, and a variety of other topics.

eSafe Gateway® and eSafe Mail® of Aladdin Knowledge Systems Ltd. are typical spam blocking facilities that can block incoming or outgoing email based on the sender, recipient, body text or subject text of an email message. Administrators can block messages containing specific keywords. For example, they can block email containing profanity or confidential project names. This feature blocks messages that violate corporate policies, thereby allowing full unattended enforcement of these policies. They can also prevent attacks by hackers or vandal programs that use SMTP as a way of sending stolen information out of the network.

One of the major problems with spam detection is that classifying an email as spam is carried out according to subjective examination rather than objective examination. For example, an email message comprising the word “travel” may be classified as spam when received in the user's office email box; however, when received at the home email box of the same user, it can be considered non-spam, since the user may be interested in travel deals. Therefore, a subjective examination results with a significant amount of false-positives.

It is an object of the present invention to provide a method and system for detecting spammers and blocking spam, which results with less false-positives than the prior art methods for blocking spam.

### SUMMARY OF THE INVENTION

In one aspect the present invention is directed to a method for indicating a sender of an email message as spammer, the method comprising the steps of: obtaining an identifier associated with the real identity of the sender; relating the email message to the identifier; calculating the mail flow rate of the identifier; and if the mail flow rate exceeds a predefined threshold, determining the real sender associated with the identifier as a suspected spammer and/or determining the email as suspected of being spam. The method may further comprise the step of: adding to the email message an indication about being spam; and digitally signing the email message with a private key.

The private key may be stored within a server that performs spam testing, within the sender's machine, within a security token associated with said sender, within a cellular telephone of the user, etc.

The identifier may be the sender's identity, the IP address of the machine of the sender during a login session to a network, data associated with the sender and stored within the sender's machine, data associated with the sender and stored within a security token of the sender, data associated with the sender and stored within the computer of the sender, the sender's identity on a the network to which the sender is connected to, the number of a cellular telephone of the user, and so forth.

The method may further comprise the steps of: upon determining the real sender as a suspected spammer, examining the content of the email message to obtain an additional indication of the email message being spam, preventing the email message and further email messages sent by the real sender to reach to the destination thereof, putting the email message and further email messages sent by the sender into quarantine until more determinate conclusions is obtained, activating an alert procedure, etc. The alert procedure may comprise informing an operator about a spam suspicion from the real sender.

According to a preferred embodiment of the invention, indicating the real identity of the sender is carried out by steps including: storing the identifier in a secured location; upon logging in the sender to a network and/or his computer, retrieving the identifier form the secured location; and associating the IP address of the sender with the identifier. The secured location may be a cookie within the user's computer, an encrypted cookie within the user's computer, a security token, a memory within a cellular telephone of the user.

According to a preferred embodiment of the invention, indicating the real identity of the sender is carried out by the steps of: providing a security token; storing an identifier associated with the user within the security token; and adding an identifier associated with the security token to an email message sent by the sender.

The method may further comprise the steps of: storing a private key within the security token; and digitally signing the email message by the private key.

According to a preferred embodiment of the invention, the threshold is determined according to statistical measurements of mail flow rate of the real user.

In another aspect the present invention is directed to a system for indicating a sender of an email message as spammer, the system comprising: a facility for identifying the real identity of a sender of an email message; a facility for counting the number of email messages sent by the sender; a facility for indicating the sender as spammer by comparing the email flow rate of said sender with a threshold; and a facility for blocking email messages sent from a sender suspected as being a spammer.

According to a preferred embodiment of the invention the facility for identifying the real identity of a sender of an email message is a program executed on the gateway of the local network to which the sender is connected to. According to one embodiment of the invention the program is invoked during a login session to a network. According to another embodiment of the invention the program is invoked during a logon session of the sender to his computer system.

According to one embodiment of the invention the real identity of a sender of an email message is stored within the computer of the sender. According to another embodiment of the invention the real identity of a sender of an email message is stored within the computer of the sender. within a security token associated with the sender.

According to a preferred embodiment of the invention, indicating the sender as spammer is based on comparing the email flow rate of the sender with a threshold thereof.

The system may further comprise a facility for digitally signing an email message with additional information, such as the real identity of the sender, the identity of the signing facility, the identity of the manufacturer of system that carries out the spam inspection, indication about the real sender being a spammer or a legitimate user, indication about the email message being a spam or legitimate email message, and so forth.

Preferably, said facility for identifying the real identity of a sender of an email message is executed on a computerized facility such as a gateway server, an ISP server, a mail server, a computer of a user, a security token, a server of a cellular network, or a cellular telephone of a user.

### BRIEF DESCRIPTION OF THE DRAWINGS

The present invention may be better understood in conjunction with the following figures:

FIG. 1 schematically illustrates the operation and infrastructure of email delivering and blocking, according to the prior art.

FIG. 2 is a flowchart of a method for detecting spam, according to a preferred embodiment of the invention.

FIG. 3 is a flowchart of a method for detecting spam, according to a further embodiment of the invention.

FIG. 4 schematically illustrates a method for detecting and blocking spam and spammers, according to a preferred embodiment of the invention.

FIG. 5 schematically illustrates an infrastructure on which the present invention can be implemented.

### DETAILED DESCRIPTION OF PREFERRED EMBODIMENTS

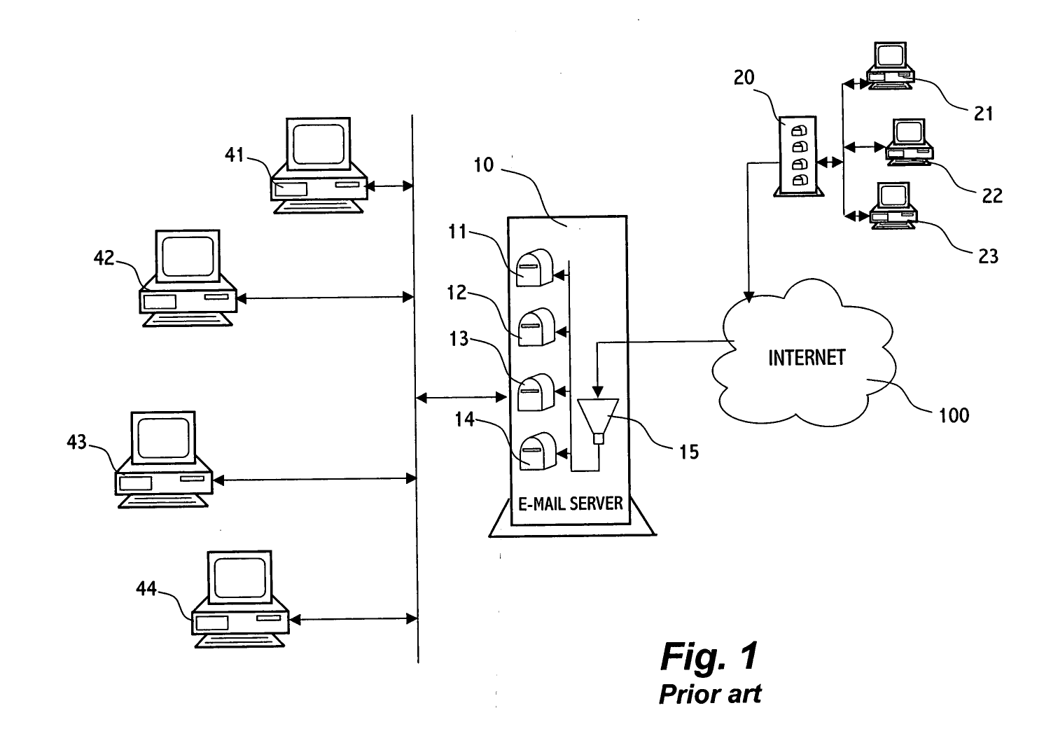

FIG. 1 schematically illustrates the operation and infrastructure of email delivering and blocking, according to the prior art. A mail server 10 maintains email accounts 11 to 14, belonging to users 41 to 44, respectively. Another mail server 20 serves users 21 to 23. The mail server 10 also comprises an email blocking facility 15, for detecting the presence of malicious code within incoming email messages.

An email message sent from, e.g., user 21 to, e.g., user 42, passes through mail server 20, through Internet 100, until it reaches mail server 10. At mail server 10, the email message is scanned by blocking facility 15, and if no malicious code is detected, it is then stored in email box 12, which belongs to user 42. The next time user 42 opens his mailbox 12 he finds the delivered email message.

One of the major problems with detecting spam is the fact that the identity of the sender of an email message can be faked. Actually, the identity of a sender is stored as data in a field of an email message, and therefore it is quite easy to fake.

The staff of Aladdin Knowledge Systems Ltd. has discovered that at the sender's side the real identity of a user can be detected, regardless of the content of the sender's field in an email message. Consequently the staff has come to the conclusion that when the real identity of a sender is known, detecting suspected spam can be carried out by relatively simple examinations such as the number of email messages sent from a sender during a period of time. For example, sending 10 email messages from one sender during a minute seems to be a legitimate operation; however, sending 200 email messages in the course of a minute may be quite unusual, and therefore is suspicious.

The term “mail flow rate” of a sender refers herein to any examination taking into consideration the number of email messages sent from a single sender. For example, the mail flow rate may be the number of email messages sent from a sender during a time period. Examples of time periods: 1 minute, 5 minutes, 2 hours, and even infinite, i.e., once the number of email messages sent exceeds, e.g., 2000 email messages, the sender may be treated as a suspected spammer and his email messages may be treated as suspected spam.

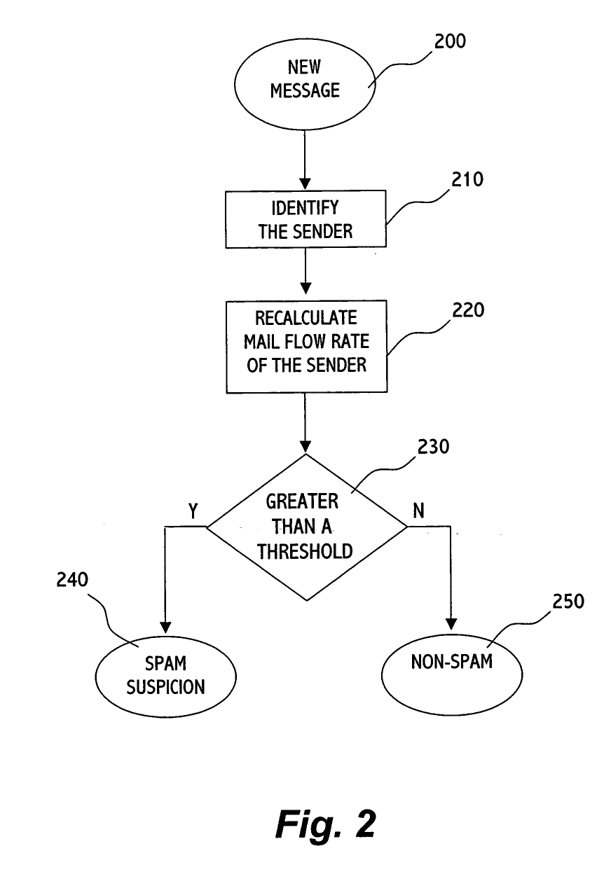

FIG. 2 is a flowchart of a method for detecting spam, according to a preferred embodiment of the invention. The method can be carried out at a point where the real identity of the sender of an email message can be detected, e.g., at the gateway to the local area network to which the sender logs in.

At block 200, an email message sent from a sender arrives to a point where the “real identity” of the sender can be identified, e.g., the gateway of a local area network.

At block 210, the sender of the email message is identified. This subject is further detailed hereinafter.

After the real identity of the sender has been identified, the email flow rate of the sender is calculated at block 220.

From block 230, if the mail flow rate of the sender is greater than a given threshold, then, on block 240, spam suspicion is raised and/or the sender is a suspected spammer; otherwise, on block 250, no spam suspicion is raised.

The possibility to relate an email message to the real sender thereof enables to implement more determinate criteria than the criteria used in the prior art, which, due to the absence of certainty regarding the identity of a sender, have to employ alternative and/or additional means of examinations, such as examining the content of an email message. Accordingly, the present invention provides means of detecting spammers which results in fewer false positives than any other method known in the art.

The threshold is actually individual data of a user. For example, for a user that sends 10 email messages per day, a threshold of 50 email messages per minute may be sufficient, however, for a user that sends 500 email messages per day a threshold of 50 email messages may be too small. According to a preferred embodiment of the invention, the threshold is determined by keeping track on the user's mailing activities, and employing statistical analysis to determine the threshold for indicating spam suspicion of the user.

According to one embodiment of the invention, email massages are delayed on the sender's side for a period of time, e.g., 5 minutes. In the event a user is determined as a suspected spammer, further operations may be carried out, such as increasing the delay of email messages sent from the user, alerting an operator, putting the sender's email messages into quarantine until a more determent conclusion is obtained, etc.

Of course, a user may send an unusual amount of email messages for legitimate reasons. In this case, a user can coordinate this act with an operator, who may change the spam detection parameters of the user, e.g., by increasing the threshold of the mail flow rate of the specific user for a certain time period, or even permanently. For example, a user sends each month a digital magazine to its subscribers. In this case an operator can set the spam detection criterion of this specific user to a maximum of 500 email messages per 5 minutes for the first day of every month.

Identifying the Real Sender of an Email Message

An email message comprises a field which stores the email address of the sender thereof. The content of this field can be amended quite easily, and therefore faking the real email address of a sender is very easy, thereby preventing the possibility of relating an email message to the real sender thereof. Thus, a spammer can bypass the most basic indicator for spam suspicion—an unusual number of email messages sent from a sender, quite easily.

U.S. patent application Ser. No. 11/062,820, of the present applicant, discloses that the real identity of a user can be determined by a cookie stored on his or her computer. This patent application is incorporated by reference for all purposes as if fully set forth herein. The cookie may be retrieved at the log-in process of a user of a local area network, resulting in the possibility to associate the IP address of a user's machine with the real identity of the user. It should be noted that a machine, e.g., a desktop computer, may serve a plurality of users, and sometimes even at the same time. According to this embodiment, on the log-in process to a computer the identity of the user (e.g., the user's account) is stored in a cookie, and when the user logs in to the network, his real identity can be retrieved from the cookie, and later on, e.g., at the gateway of the local network, the IP address of the log-in session can be associated with the user.

PCT Application Number IL 2005/000930, of the present applicant, discloses that during the log-in process, once a user has been identified, his or her current IP address and real identity can be sent to a server, and later on used to relate email messages sent from this IP address to the real sender thereof. This PCT application is incorporated by reference for all purposes as if fully set forth herein. Thus, according to this solution even the cookies become unnecessary.

It should be noted that for the purpose of detecting spam, according to a preferred embodiment of the present invention it is adequate to know that certain email messages have been sent from a certain sender, rather than knowing his name, address, etc.

According to one embodiment of the invention, once a user logs into the local area network of an organization, his or her IP address becomes the unique identifier of the user within the network. As described in U.S. Ser. No. 11/062,820, at a gateway of a local area network it is possible to block outgoing email messages and it is possible to know from which IP address an email message has been sent. Thus, even if a user fakes his or her identity in an email message, at the gateway it is still possible to relate the email message to the IP address of the machine from which the message has been sent, and since the IP address of a log-in session is associated with a user, the email message is related to this user. In order to send a great number of email messages without raising suspicion, a spammer has to log-in a plurality of times, since each time he or she may be assigned a different IP address on the log-in process, and each time he or she has to send a small amount of email messages. The plurality of log-ins slows the process, and thereby results in unprofitable effort to the spammer, which may cause him or her to leave the spamming occupation.

Generally speaking, the identity of a user is known at the sender's side. For example, an ISP (Internet Service Provider) knows the real identity of a user when the user uses its services. The identity of a user is known also to an email server. Thus, the term “a server at a user's side” includes an ISP server and email server.

According to one embodiment of the invention, the identifier associated with a user is stored within a security token. From the point of view of the present invention, a security token is a device which securely stores a data entity, such as an ID, a cryptographic key, a seed for generating a one-time-password, etc. Thus, when a user sends an email message, the email client program (e.g., Outlook) may retrieve the secure data (ID, etc.) from the security token, and add it to the email message.

Digitally Signing an Email Message

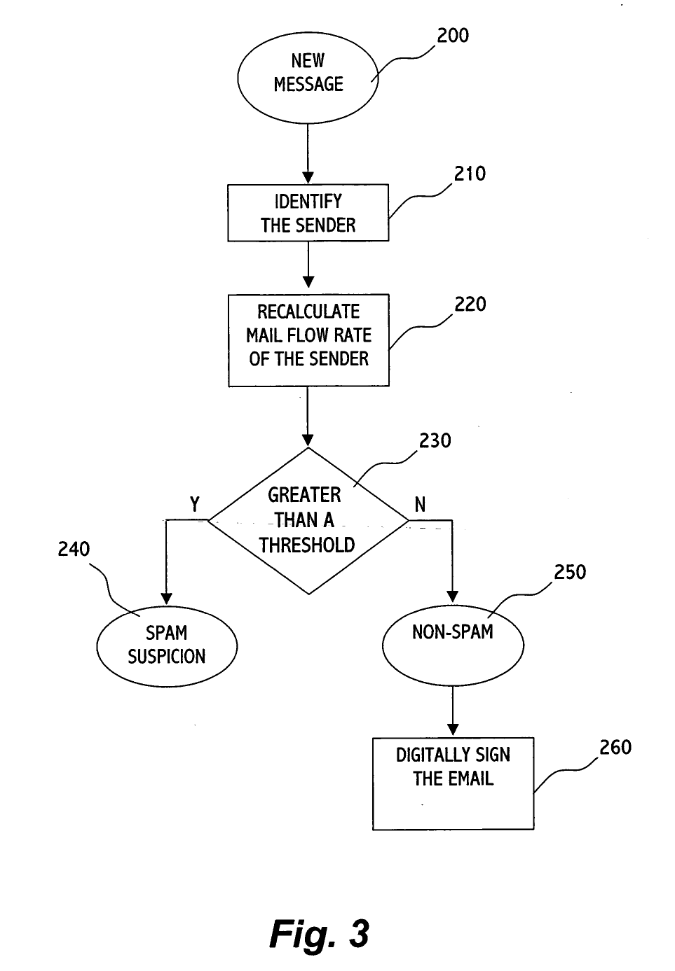

According to a preferred embodiment of the invention, an email message (or even a part of it) can be digitally signed, thereby providing the recipient the possibility to verify that some details, such as the identity of the sender, are authentic. The act of digitally signing an email message is expressed in block 260 of FIG. 3. The digital signature may be of the server that filters spam, or the user's digital certificate, i.e. a digital signature which has been issued by a certification authority to a user, and therefore it comprises the details of the certification authority.

Nowadays, security tokens are coupled with programming ability, which enables downloading a document from a host to a token, generating a digital signature of the document at the token, and returning the digital signature from the token to the host. Thus, the private key stored within the token remains secure and almost impossible to be faked, since it never leaves the token.

Informing a Recipient of Legitimate Email Message

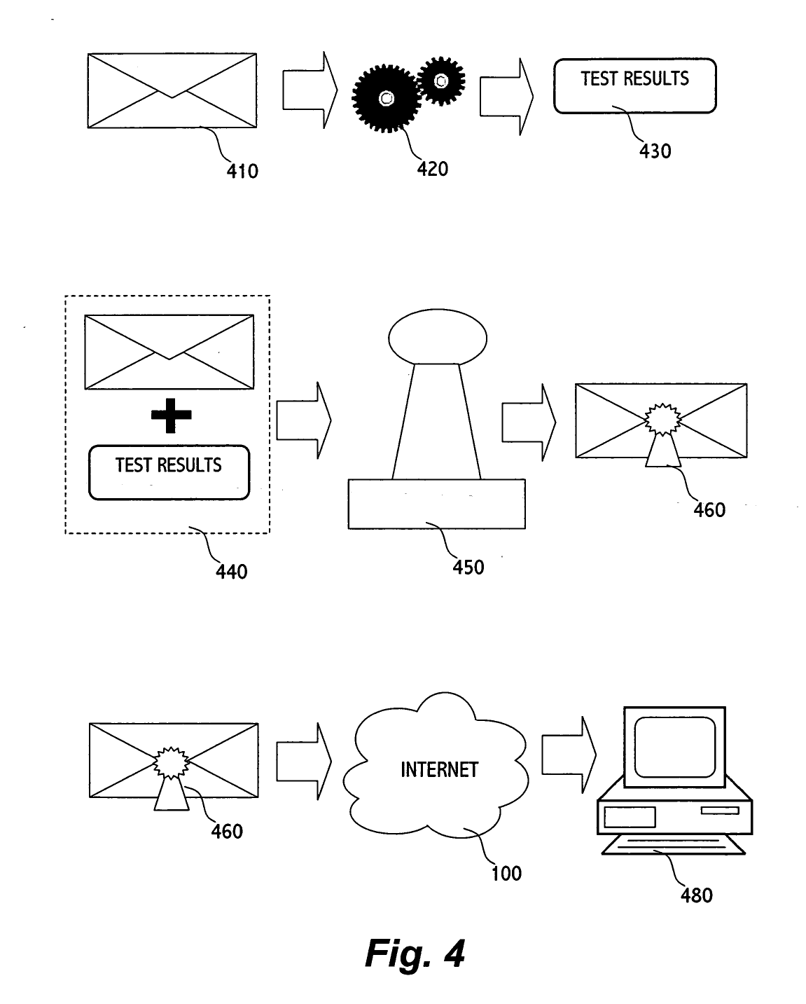

FIG. 4 schematically illustrates a method for detecting and blocking spam and spammers, according to a preferred embodiment of the invention.

An email message 410 is inspected for spam at inspecting facility 420 on the sender's side.

The results of the inspection 430 (i.e., suspicion of being spam or legitimate email message) are added to the email message 410, resulting in a new file 440. File 440 is digitally signed by PKI utility 450, resulting in a new file 460. File 460 can also include the identity of the spam inspecting facility 420, its public key, the expiration date, etc.

File 460 is then sent to the recipient 480 through the Internet 100.

The digital signature added to an email message informs the recipient thereof (or a server at the recipient's side, etc.) of the identity of the spam inspecting facility operating on the sender's side. At the recipient's side the email message can be treated as legitimate or spam according to this information. In the event of a reliable inspecting facility, the recipient can follow the recommendations of the signed content (i.e., legitimate or spam), and act accordingly.

For example, a spam detection system adds a digital signature to any email message found to be legitimate. The private key is stored at the spam inspecting facility, and the public key can be obtained (e.g., by the recipient) thorough the Internet. Thus, the digital signature enables a recipient (or a server at the recipient's side, etc.) to verify that the email message has been inspected by a certain spam detection facility (which may have a good reputation), and was found as legitimate or suspected as being spam.

Referring again to FIG. 1, according to a preferred embodiment of the present invention, spam detection utility can be placed at the server 20. Thus, according to a preferred embodiment of the invention, a system for indicating an email message sender as a spammer comprises the following components:

A facility for identifying the real identity of a sender of an email message. This facility can be a program executed on the gateway of the local network the sender is connected to (preferably during a login process to the user's computer and/or network), data within the user's computer, data within a security token, and so forth.

A facility for counting the number of email messages sent by the user.

A facility for indicating a user as spammer (e.g. by comparing the email flow rate of the user with a threshold thereof).

A facility for blocking email messages sent from a sender suspected as being a spammer.

The system may further comprise:

A facility for digitally signing an email message. The signed content may comprise also the real identity of the sender thereof, his or her real name, an identifier associated with the sender of the email, the identity of the signing facility (e.g., the manufacturer of the spam inspecting system) and information about the results of the inspection (spam or legitimate email message, etc.)

It should be noted that nowadays cellular telephones can be used for propagating spam. Since a cellular telephone may fall under the definition of a user's machine, a cellular message may fall under the definition of an email message, a server at a cellular telephone network may fall under the definition of a gateway server, the SIM of a cellular telephone may fall under the definition of a security token, etc., the present invention is effective also for cellular telephone spam.

For example, an identifier associated with a user is stored in a memory within the cellular telephone of the user, e.g. SIM. Thus, from the point of view of the present invention, the SIM of a cellular telephone is a non-volatile memory installed within a user's machine. Moreover, the threshold can be stored within the user's machine (i.e., cellular telephone) as well as in a server at the cellular telephone network.

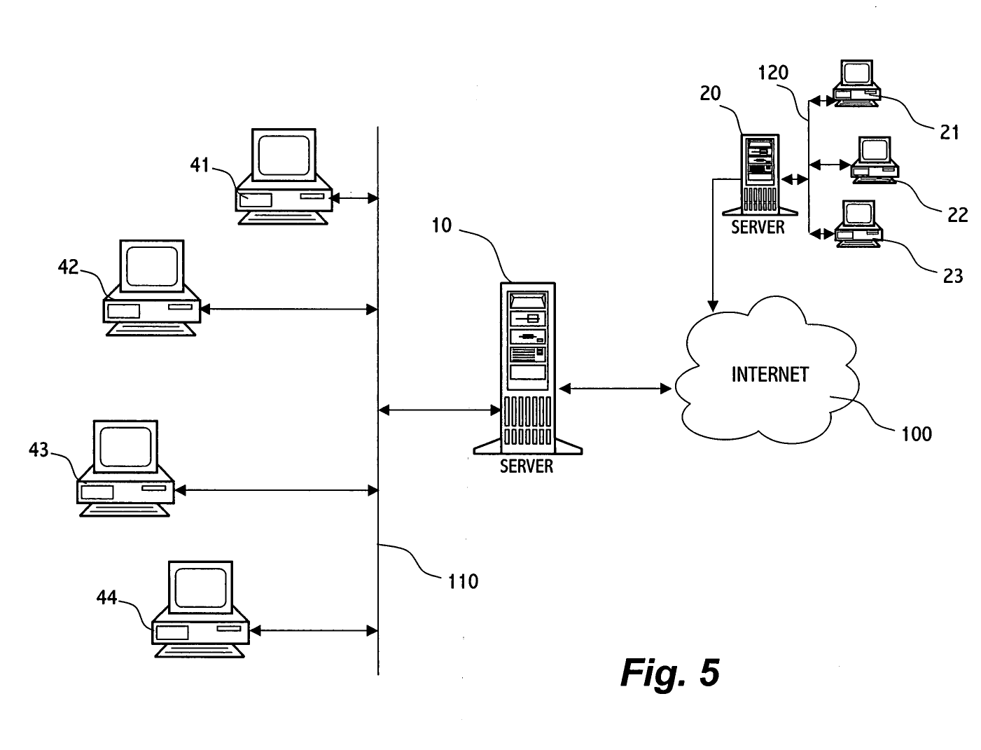

FIG. 5 schematically illustrates an infrastructure on which the present invention can be implemented. Servers 10 and 20 may be gateway servers, ISP (Internet Service Provider) servers, mail servers, cellular phone servers, etc. Networks 110 and 120 may be local area networks (LAN), wide area networks (WAN), virtual private networks (VPN), cellular phone networks, etc. The facility for identifying the real identity of a sender of an email message may be executed on a computerized facility such as a gateway server, an ISP server, a mail server, a computer of a user, a security token, a server of a cellular network, a cellular telephone of a user, and so forth.

Those skilled in the art will appreciate that the invention can be embodied in other forms and ways, without losing the scope of the invention. The embodiments described herein should be considered as illustrative and not restrictive.

1. A method for indicating a sender of an email message as spammer, the method comprising the steps of:
obtaining an identifier associated with the real identity of said sender;
relating said email message to said identifier;
calculating the mail flow rate of said identifier; and
if said mail flow rate exceeds a predefined threshold, performing an operation selected from the group consisting of: determining the real sender associated with said identifier as a suspected spammer, determining said email message as suspected of being spam.

2. A method according to claim 1, further comprising the step of:
adding to said email message indication about being spam or legitimate message according to said determining.

3. A method according to claim 1, further comprising the step of:
digitally signing said email message with a private key.

4. A method according to claim 3, wherein said private key is stored within an element selected from the group comprising: a server that performs spam testing, said sender's machine, a security token of said sender, a memory within a user's cellular telephone.

5. A method according to claim 1, wherein said identifier is selected from a group comprising: said sender's identity, the IP address of the machine of said sender during a login session to a network, data associated with said sender and stored within said sender's machine, data associated with said sender and stored within a security token of said sender, data associated with said sender and stored within the computerized machine of said sender, data associated with said sender and stored within a cellular telephone of said sender, said sender's identity on a the network to which said sender is connected to.

6. A method according to claim 1, further comprising the step of:
upon determining said real sender as a suspected spammer, performing an operation selected from the group consisting of: further examining the content of said email message to obtain an additional indication of being spam, preventing said email message and further email messages sent by said real sender to reach to the destination thereof, putting said email message and further email messages sent by said sender into quarantine until a more determinate conclusion is obtained, and activating an alert procedure.

7. A method according to claim 6, wherein said alert procedure comprises informing an operator about a spam suspicion from said real sender.

8. A method according to claim 1, wherein indicating the real identity of said sender is carried out by the steps of:
storing said identifier in a secured location;
upon logging in said sender to a network and/or his computer, retrieving said identifier from said secured location; and
associating the IP address of said sender with said identifier.

9. A method according to claim 8, wherein said secured location is selected from the group comprising: a cookie within said user's computer, an encrypted cookie within said user's computer, a memory within the user's machine, a secured memory within the user's machine, a memory within a security token, and a secured memory within a security token.

10. A method according to claim 1, wherein indicating the real identity of said sender is carried out by the steps of:
providing a security token;
storing an identifier associated with said user within said security token; and
adding an identifier associated with said security token to an email message sent by said sender.

11. A method according to claim 10, further comprising the steps of:
storing a private key within said security token; and
digitally signing said email message by said private key.

12. A method according to claim 1, wherein said threshold is determined according to statistical measurements of mail flow rate of said real user.

13. A system for indicating a sender of an email message as spammer, the system comprising:
a facility for identifying the real identity of a sender of an email message;
a facility for counting the number of email messages sent by said sender;
a facility for indicating said sender as spammer by comparing an email flow rate of said sender with a threshold thereof; and
a facility for blocking email messages sent from a sender suspected as being a spammer.

14. A system according to claim 13, wherein said facility for identifying the real identity of a sender of an email message is a program executed on the gateway of the local network to which said sender is connected to.

15. A system according to claim 14, wherein said program is adapted to being invoked during a login session to a network.

16. A system according to claim 14, wherein said program is adapted to being invoked during a login session of said sender to his or her computer system.

17. A system according to claim 13, wherein the real identity of a sender of an email message is stored within the computer of said sender.

18. A system according to claim 13, wherein the real identity of a sender of an email message is stored within a security token associated with said sender.

19. A system according to claim 13, further comprising:
a facility for digitally signing an email message with additional information.

20. A system according to claim 19, wherein said additional information comprises the real identity of said sender.

21. A system according to claim 19, wherein said additional information comprises the identity of the signing facility.

22. A system according to claim 19, wherein said additional information comprises the identity of the manufacturer of system that carries out the spam inspection.

23. A system according to claim 19, wherein said additional information comprises indication about being said real sender being a spammer or a legitimate user.

24. A system according to claim 19, wherein said additional information comprises indication about being said email message a spam or legitimate email message.

25. A system according to claim 13, wherein said facility for identifying the real identity of a sender of an email message is executed on a computerized facility selected from the group consisting of: a gateway server, an ISP server, a mail server, a computer of a user, a security token, a server of a cellular network, and a cellular telephone of a user.
